(19) United States
(12) Patent Application Publication
(10) Pub. No.: US 2015/0028039 A1
(43) Pub. Date: Jan. 29, 2015

(54) Vehicle Tank System for Storing a Fuel in an Extremely Cold State

(71) Applicant: Bayerische Motoren Werke Aktiengesellschaft, Muenchen (DE)

(72) Inventors: Oliver KIRCHER, Germering (DE); Klaas KUNZE, Muenchen (DE); Bastian LANDECK, Unterhaching (DE)

(21) Appl. No.: 14/496,944

(22) Filed: Sep. 25, 2014

Related U.S. Application Data
(63) Continuation of application No. PCT/EP2013/053024, filed on Feb. 14, 2013.

(30) Foreign Application Priority Data
Mar. 26, 2012 (DE) 10 2012 204 820.0

(51) Int. Cl. B60K 15/03; F17C 13/02; F17C 3/08

(52) U.S. Cl. CPC B60K 15/03; F17C 3/08; F17C 13/02; B60K 2015/03309
USPC 220/592.27; 137/14

(57) ABSTRACT

A vehicle tank system for storing a fuel in an extremely cold state is provided. The vehicle tank system includes an inner tank that accommodates the fuel and an outer skin that surrounds the inner tank to form an insulation layer approximately constituting a vacuum. The vehicle tank system also includes a vacuum pump that is permanently provided in the vehicle and is connected to the insulation layer. The vacuum pump is configured to increase the quality of the vacuum if the quality of the vacuum does not meet predetermined requirements.

### CROSS REFERENCE TO RELATED APPLICATIONS

This application is a continuation of PCT International Application No. PCT/EP2013/053024, filed Feb. 14, 2013, which claims priority under 35 U.S.C. §119 from German Patent Application No. 10 2012 204 820.0, filed Mar. 26, 2012, the entire disclosures of which are herein expressly incorporated by reference.

### BACKGROUND AND SUMMARY OF THE INVENTION

The invention relates to a vehicle tank system for storing a fuel in an extremely cold state. The vehicle tank system includes an inner tank that accommodates the fuel, and an outer skin that surrounds the inner tank while forming an insulation layer representing a vacuum. Furthermore, the invention relates to an operating method for the vehicle tank system. Conceivable fuels that may be stored in such a tank system include, for example, liquid hydrogen, cryogenic hydrogen in the supercritical state, liquid natural gas, or other liquefied or extremely cold gases, which are stored and carried along, particularly as an energy source for the drive of the vehicle or the motor vehicle. With respect to related art, reference is made particularly to German Patent Document DE 10 2006 025 657.

For an ecologically and economically acceptable mobile storage of cryogenic gases, it is necessary to reduce to a minimum the entering of heat from the environment into the stored gas, in order to reduce unwanted and disadvantageous pressure rises in the storage container (tank) and losses of gas that may result therefrom as a result of a proportional release of stored gas, for avoiding an unacceptably high pressure buildup. Tank systems for storing fuels in an extremely cold state therefore have a vacuum superinsulation, which includes reflector shields separated by spacer layers (compare German Patent Document DE 102006057663 A1), and operates at absolute pressure values in the range of between 10⁻⁵ mbar and 10⁻³ mbar (millibar).

For the generating and sustainability of this vacuum in the insulation layer of the tank for several years, a more expensive baking-out and evacuating process lasting for several days is required during the manufacturing process of such a cryo-tank equipped with a vacuum superinsulation, which, in practice, cannot be implemented economically for a large-scale production. Furthermore, for ensuring the required vacuum quality for the entire service life cycle of such a cryogenic tank or gas storage device, a getter has to be provided in its vacuum superinsulation (compare, for example, DE 102008031344 A1). Such a getter is also expensive, particularly if an exchange of the getter were to become necessary.

Usually the withdrawal of stored gas from the tank takes place while utilizing an overpressure existing in the tank, which has to be present or maintained for this purpose, and for a more intensive withdrawal, and particularly also for a nearly complete evacuation of the tank. This is usually implemented by way of a heat exchanger provided in the storage volume of the tank (compare, for example, DE 10 2006 025 657 A1). By way of this heat exchanger, heat may be introduced into the storage volume or the inner tank. Currently, so-called cryo-pressure tanks are being developed, in which hydrogen may be stored in the supercritical state. In such cryo-pressure tanks, a sufficiently high pressure could be available in almost all operating conditions of a vehicle equipped therewith, without any additional introduction of heat into the tank. Nevertheless, such an expensive heat exchanger would also have to be provided in the case of a cryo-pressure tank in order to permit a complete evacuation of the tank, even if the vehicle was not parked in the meantime. In addition, such a heat exchanger has to be protected at high expenditures against risks resulting from a possible leak because, in the event of a leak, stored gas could leak from the tank by way of the additional lines assigned to the heat exchanger.

Reference is briefly made to German Patent Document DE 695 16 117 T2, which describes a refrigerator having a vacuum insulation that is maintained by way of a permanently provided vacuum pump.

An object of the invention is to provide a vehicle tank system for storing a fuel in an extremely cold state that has a vacuum insulation layer that is easier to handle.

This object may be achieved by a vacuum pump that is permanently provided in the vehicle and connected to the insulation layer, such that the quality of the vacuum may be enhanced when the vacuum quality does not meet the specified demands.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of the vehicle tank system according to embodiments of the invention; and

FIG. 2 is a flowchart showing a method of operating the vehicle tank system according to embodiments of the invention.

### DETAILED DESCRIPTION OF THE DRAWINGS

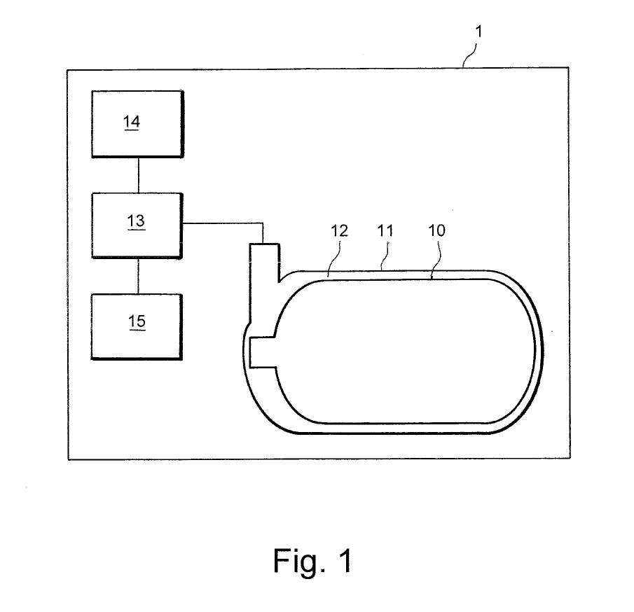

FIG. 1 shows an embodiment of a vehicle tank system 1 for storing a fuel in an extremely cold state. The vehicle tank system 1 includes an inner tank 10 that accommodates the fuel, and an outer skin 11 that surrounds the inner tank 10 while forming an insulation layer 12 approximately representing a vacuum. A vacuum pump 13 is permanently provided in a vehicle in which the vehicle tank system 1 is arranged. As shown in FIG. 1, the vacuum pump 13 is connected to the insulation layer 12. The vacuum pump 13 is configured to enhance the quality of the vacuum when the quality of the vacuum does not meet specified demands.

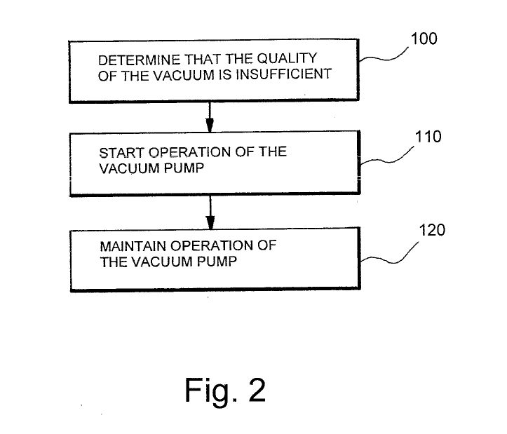

FIG. 2 shows a method of operating the vehicle tank system 1. Embodiments of the present invention use a vacuum pump 13 that is permanently installed in the vehicle in order to guarantee the vacuum quality for practically the entire service life of the vehicle cryo-tank. The term “vacuum quality” is known to a person skilled in the art and means that a certain tolerance range is met for the absolute pressure existing in the vacuum or the so-called “near-vacuum”. For example, a sufficient vacuum quality may be present for a vehicle tank system when the absolute pressure in the vacuum insulation layer 12 is less than 10⁻³ bar (0.001 millibar). Therefore, when it is determined in a suitable manner, preferably by an electronic control unit, that the quality of the vacuum currently existing in the insulation layer 12 is not sufficient (step 100), the operation of the vacuum pump 13 will be started (step 110), preferably by way of the control unit, and will be maintained either for a certain specified time period or until the desired vacuum quality has been restored (step 120).

The determination of the current (or desired) vacuum quality may be achieved in various fashions. Thus, by way of an absolute-pressure sensor sensing even the lowest pressure values, the pressure in the vacuum insulation layer may be monitored, and when sufficient energy is available for the operation of the vacuum pump, preferably the operation of this vacuum pump 13 may be started. Thereby, the vacuum insulation layer 12 of the vehicle tank system 1 may continue to be evacuated until an absolute pressure below a specified limit value or desired value of the above-mentioned magnitude of, for example, 10⁻³ mbar exists in this insulation layer 12. Instead of the absolute pressure, which may be measured only at relatively high expenditures, a replacement quantity may also be used as a function thereof. A conceivable and preferred replacement quantity, which correlates positively with the absolute pressure in the vacuum insulation layer 12, is the heating of the operating medium occurring in a specified time unit by the introduction of heat by way of the vacuum insulation layer 12. At a vehicle tank system 1, the pressure and the temperature of the fuel situated in the inner tank 10 are usually measured continuously. By way of filed tables and/or model computations, it may then be determined from the heating of the fuel within a certain time unit, while appropriately taking into account further influences and marginal conditions, whether a sufficient or an insufficient vacuum quality is present in the insulation layer 12 between the inner tank 10 and the outer skin 11.

The vacuum pump 13, which is preferably connectable by way of a switchable vacuum valve or generally connected to the vacuum insulation layer 12 of the vehicle tank system 1, is fixedly installed in the vehicle. If required, the vacuum pump 13 is triggered by an electronic control unit that analyzes suitable signals from suitably installed sensors, such as a pressure sensor or additionally a temperature sensor. Preferably, if sufficient energy is available for the operation of a vacuum pump 13, the operation of this vacuum pump 13 may be started, and thereby the vacuum insulation layer 12 of the vehicle tank system 1 may be further evacuated until the vacuum quality again meets the demands, which may be determined in the same manner as the current vacuum quality within the scope of the continuing monitoring. However, it is also conceivable to operate the vacuum pump 13 for defined time periods which, in turn, may be a function of current marginal conditions. In principle, it is also conceivable to assume, after the expiration of a certain time period since the last start of the operation of the vacuum pump 13, that the current vacuum quality no longer meets the requirements so that, within specified time periods, the vacuum pump 13 may always be operated for a certain specified time period, which may also be a function of current marginal conditions.

Sufficient energy for operating the vacuum pump 13 will, for example, be available when the vehicle itself is operating, because then the energy converter 15, which is also operated in the vehicle, may obtain the required energy from the fuel stored in the tank 10. However, sufficient energy for operating the vacuum pump 13 may also be available when the vehicle is parked (stopped) and/or a drive for the vacuum pump 13 may be supplied from an external energy source, such as in the form of electric current from the power supply system.

The vacuum pump 13, which preferably may be a turbo-molecular pump or a comparatively robust vacuum pump, which is capable of generating vacuum pressures of the magnitude of 10⁻³ or less, may be directly or indirectly driven by the drive system 14 of the vehicle. In this case, a direct drive, as required, is conceivable with the insertion of a transmission by a drive shaft of the vehicle. For an indirect drive, an electric motor comes into consideration, which is supplied, for example, from a fuel cell that is a component of the vehicle drive system 14. The start of the operation of the vacuum pump 13 preferably takes place in partial-load phases or coasting phases of the vehicle drive system 14, in order to minimize the negative effect on the efficiency of the drive. When a “loaded” internal-combustion engine is a component of the vehicle drive system 14, particularly when a turbo-molecular pump is used as the vacuum pump 13, its drive may be synergetically coupled with the already present exhaust gas turbine of the internal-combustion engine.

When, as a result of a long stoppage phase of the vehicle, a low partial quantity of the fuel stored in the tank 10 has to be released to avoid unacceptably high pressures in the tank 10, this released partial quantity may be supplied to an energy converter 15 that generates energy therefrom for the operation of the vacuum pump 13, so that the vacuum pump 13 may also be started during an extensive stoppage time of the vehicle.

For the purpose of an advantageous further development, a vacuum pump 13 provided according to embodiments of the invention may be combined with a device for increasing the pressure in the vacuum insulation layer 12, and may be utilized for actively regulating the absolute pressure in the “near-vacuum” or the vacuum quality existing there. As known, during long withdrawal phases without any interruption, particularly during full-load phases of the consuming device of the fuel, the tank pressure may fall to such an extent, without any active introduction of heat into the inner tank 10, that a reliable supplying of the consuming device will no longer be guaranteed. As initially explained, in the related art, by way of a heat exchanger provided in the storage volume of the tank, heat is then introduced into the storage volume for increasing the pressure. Such a heat exchanger will no longer be required when a targeted heat introduction into the storage volume takes place by way of the outer skin 11 and the vacuum insulation layer 12. For this purpose, the so-called “near-vacuum” is reduced to such an extent that the desired amount of heat may arrive in the inner tank 10 from the environment by way of the walls of the tank 10. In other words, the quality of the vacuum is reduced when the fuel pressure existing in the tank 10 (and continuously measured) falls below a desired minimal value. Summarizing, by way of this further development, the quality of the vacuum is regulated by way of the starting and stopping of the vacuum pump 13, as a function of the pressure existing in the inner tank 10, as well as of the temperature prevailing there. In this case, for a reduction of the vacuum quality in the insulation layer 12, by opening a suitably provided valve, a small amount of ambient air may be introduced into the vacuum insulation layer 12; however, a targeted degrading of the “near-vacuum” of the insulation layer 12 may also take place by way of a gas that has a high thermal conductivity.

Advantageously, a vacuum pump 13 provided according to embodiments of the invention may also be used in the event of a leakage at the vacuum in order to prevent or at least delay a complete loss of the vacuum. As a result, an opening of safety devices in the event of a loss of the vacuum caused by the rapidly rising introduction of heat and the tank pressure may be completely prevented or delayed to such an extent that sufficient time is available for suitable measures and for a warning. In particular, however, the manufacturing process for a tank/storage container used according to embodiments of the invention may be significantly shortened and thereby also optimized with respect to costs, because the baking-out and evacuating process may be significantly shortened or even partly eliminated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle tank system for storing a fuel in an extremely cold state, the vehicle tank system comprising:
an inner tank that accommodates the fuel;
an outer skin that surrounds the inner tank while forming an insulation layer approximately representing a vacuum; and
a vacuum pump that is permanently provided in a vehicle in which the vehicle tank system is arranged, wherein:
the vacuum pump is connected to the insulation layer, and
the vacuum pump is configured to enhance quality of the vacuum when the quality of the vacuum does not meet specified demands.

2. The vehicle tank system according to claim 1, wherein the vacuum pump is directly or indirectly driven by a drive system of the vehicle.

3. The vehicle tank system according to claim 1, further comprising:
a converter for generating drive energy for the vacuum pump,
wherein the converter is configured to be operated by a partial quantity of fuel released in stoppage phases of the vehicle based on a pressure increase in the inner tank.

4. The vehicle tank system according to claim 2, further comprising:
a converter for generating drive energy for the vacuum pump,
wherein the converter is configured to be operated by a partial quantity of fuel released in stoppage phases of the vehicle based on a pressure increase in the inner tank.

5. The vehicle tank system according to claim 1, further comprising a device configured to reduce the quality of the vacuum in the insulation layer in a targeted manner.

6. The vehicle tank system according to claim 1, wherein the vacuum pump is a turbo-molecular pump.

7. The vehicle tank system according to claim 1, wherein:
operation of the vacuum pump is started because of a determination that the quality of the vacuum does not meet the specified demands, and
the determination occurs when an amount of absolute pressure in the vacuum insulation layer or a replacement quantity positively correlating with the absolute pressure exceeds a limit value, or when a replacement quantity negatively correlating with the absolute pressure falls below the limit value.

8. The vehicle tank system according to claim 7, wherein the vacuum pump is operated until the absolute pressure or the replacement quantity for the absolute pressure is within a desired range.

9. The vehicle tank system according to claim 7, wherein the vacuum pump is operated only if an energy converter that processes the fuel is operated, or an external energy source is available for the vacuum pump.

10. The vehicle tank system according to claim 2, wherein the vacuum pump is operated only in operating phases of the vehicle in which the drive system is working with a sub-maximal power output.

11. The vehicle tank system according to claim 5, wherein the device sets up a greater introduction of heat via the outer skin into the inner tank, such that a desired pressure level of the fuel is built up in the inner tank.

12. An operating method for a vehicle tank system for storing a fuel in an extremely cold state, wherein the vehicle tank system includes an inner tank that accommodates the fuel; an outer skin that surrounds the inner tank while forming an insulation layer approximately representing a vacuum; and a vacuum pump that is permanently provided in a vehicle in which the vehicle tank system is arranged, wherein the vacuum pump is connected to the insulation layer, and the vacuum pump is configured to enhance quality of the vacuum when the quality of the vacuum does not meet specified demands, the operating method comprising:
determining that the quality of the vacuum does not meet the specified demands; and
starting operation of the vacuum pump based on the determination,
wherein the determination occurs when an amount of absolute pressure in the vacuum insulation layer or a replacement quantity positively correlating with the absolute pressure exceeds a limit value, or when a replacement quantity negatively correlating with the absolute pressure falls below the limit value.

13. The operating method according to claim 12, wherein the vacuum pump is operated until the absolute pressure or the replacement quantity for the absolute pressure is within a desired range.

14. The operating method according to claim 12, wherein the vacuum pump is operated only if an energy converter that processes the fuel is operated, or an external energy source is available for the vacuum pump.

15. The operating method according to claim 12, wherein:
the vacuum pump is directly or indirectly driven by a drive system of the vehicle, and
the vacuum pump is operated only in operating phases of the vehicle in which the drive system is working with a sub-maximal power output.

16. The operating method according to claim 12, wherein:
the vehicle tank system further comprises a device configured to reduce the quality of the vacuum in the insulation layer in a targeted manner, and
the device sets up a greater introduction of heat via the outer skin into the inner tank, such that a desired pressure level of the fuel is built up in the inner tank.
